(19) United States
(12) Patent Application Publication
(10) Pub. No.: US 2007/0056809 A1
(43) Pub. Date: Mar. 15, 2007

(54) Elevator Car with Maintenance Platform and Method for Maintenance of the Elevator Installation

(75) Inventors: Mario Fernandes, Mulhouse (FR); Emmanuel Kolb, Reininque (FR); Denis Sittler, Illzach (FR); Denis Wagner, Ensisheim (FR)

Correspondence Address: BUTZEL LONG, STONERIDGE WEST, 41000 WOODWARD AVENUE, BLOOMFIELD HILLS, MI, 48304, US

(73) Assignee: INVENTIO AG, Hergiswil NW (CH)

(21) Appl. No.: 11/467,938

(22) Filed: Aug. 29, 2006

(30) Foreign Application Priority Data
Aug. 30, 2005 (EP) 05107904.4

(51) Int. Cl. B66B 11/02

(52) U.S. Cl. 187/401

(57) ABSTRACT

An elevator car has a car roof which can be lowered into the passenger compartment by means of a drive device and in the lowered position serves as a platform for the maintenance personnel for the performance of maintenance and checking operations. The drive device actuates several Bowden pulls.

### BACKGROUND OF THE INVENTION

The present invention relates to an elevator car with a car roof which is lowerable into the passenger compartment and which in the lowered position serves for maintenance personnel as a maintenance platform for the performance of maintenance and checking operations, as well as to a method for maintenance of components arranged in the elevator shaft of an elevator installation.

It is known that maintenance operations at elevator components arranged in the elevator shaft are undertaken by a maintenance person standing on the car roof of the elevator car. The elevator car is for this purpose movable in the entire elevator shaft by means of an inspection control. During this process it is absolutely necessary to ensure, through additional technical measures, a safety spacing between the car roof of the elevator car and the shaft roof or between the car roof and elevator components installed in the region of the shaft roof, so as to avoid the possibility of the maintenance person being trapped.

JP 09263372 discloses a solution which ensures that such a safety spacing is kept. It is proposed therein to so design a elevator car that its car roof is lowerable into the passenger compartment so that it forms a maintenance platform from which the maintenance person carries out inspection or repair operations at elevator components fixed in the elevator shaft. Through lowering of the car roof it is achieved that the said safety spacing is guaranteed without special safety devices, such as, for example, abutment buffers pivotable into the car travel path or an additional switching device, which forms a downwardly displaced upper electrical path limitation, being required.

The lowerable car roof disclosed in JP 09263372 and serving as a maintenance platform has certain disadvantages which are briefly described in the following:

The car roof is suspended at four pull means in the form of wire cables which are led over deflecting rollers to a cable drum and able to be wound up on and unwound from this. The pull means are guided in rectilinear sections between the cable drum, which forms a part of a drive device for the car roof, and the fastening points of the pull means in the region of the corners of the car roof, wherein the horizontally oriented pull means sections extend above the car roof in the region of the surface of the car roof serving as maintenance platform. Such an arrangement of the pull means carrying the car roof has, on the one hand, the disadvantage that these restrict the area of the car roof, particularly the edge region thereof, which can be walked on and form obstacles to the accessibility of elevator components in the elevator shaft to be maintained. In that case the pull means freely extending in the compartment also cause tripping accidents of the maintenance personnel. On the other hand, the pull means arranged freely in the compartment and extending rectilinearly obstruct optimum arrangement of elevator components in the region of the car roof, for example the optimum arrangement of an upper yoke of a car frame, of terminal boxes, of roof hatches or roof railings.

### SUMMARY OF THE INVENTION

The present invention has an object of proposing an elevator car and a maintenance method of the kind stated in the introduction which do not have the stated disadvantages of the equipment cited as state of the art. In particular, an elevator car with a lowerable car roof as a maintenance platform shall thus be created in which a drive device for the car roof does not have pull means which necessarily extend rectilinearly and freely in the compartment and in that case restrict the area of the car roof which can be walked upon, represent a risk of accident and prejudice optimum arrangement of elevator components in the region of the car roof. Moreover, the solution shall be space-saving and economic.

The present invention is based on the concept of eliminating the aforesaid problems with the pull means, which are executed as open wire cable connections, of the drive device for the car roof in that the car roof is lowered and raised with the help of Bowden pulls.

The advantage of use of Bowden pulls for the drive device of the car roof consists, in particular, in that the arrangement and the course of the pull means required between the drive device and the car roof and the arrangement of the drive device moving the pull means are almost completely freely selectable without creation of additional costs by comparison with a solution having shortest possible, rectilinearly arranged pull means. The Bowden pulls require a minimum of installation space and are so arranged that they do not form any obstacles and any risk of accident for the maintenance personnel.

According to a particularly simple embodiment of the present invention, the Bowden pulls comprise flexible casing tubes and pull means guided therein, wherein respective first ends of the pull means are connected with the lowerable car roof and the corresponding ends of the flexible casing tubes are fixed to car components arranged in the upper region of the elevator car to be immovable.

In the case of a particularly stable form of embodiment of the present invention the car components arranged in the upper region of the elevator car to be immovable are present in the form of a roof frame connected with the upper edges of the side walls.

In advantageous manner the pull means are connected in the region of the second ends thereof with a drive device, wherein a movable drive part of the drive device so co-operates with the pull means in the region of the second ends thereof that a movement of the drive part produces a longitudinal displacement of the parts of the pull means leading to the car roof, wherein the ends, which correspond with the second ends of the pull means, of the flexible casing tubes are fixed in the region of the drive device to a component immovable relative thereto.

In order to save costs, the flexible casing tubes can have interruptions, wherein the ends, which are associated with the interrupt locations, of the casing tubes are fixed to the elevator car by means of retaining members and the pull means extend rectilinearly between the interrupt locations.

In the case of a particularly space-saving embodiment of the present invention the drive part, which moves the pull means, of the drive device is linearly displaceable, wherein the linearly displaceable drive part so acts on the pull means that the first ends thereof allow the car roof to lower or raise it.

Advantageously the drive device comprises a threaded spindle or a cogged belt drive or a chain drive, which serves the purpose of linearly displacing the drive part of the drive device.

A further reduction of the space requirement of the drive device is achieved in that the drive device comprises a drive input shaft with a coupling member by way of which a maintenance person causes, with the help of a crank or an electrically operated torque motor, movement of the drive part moving the pull means or displacement of the linearly displaceable drive part of the drive device.

In order to be able to produce the requisite stroke travel of the car roof with a given maximum installation length of the drive device the linearly displaceable drive part in the drive device so co-operates with the pull means in the region of the second ends thereof that displacement travels result in the sections, which lead to the car roof, of the pull means and thus a stroke travel of the car roof which correspond at least with twice the displacement travel of the linearly displaceable drive part.

A marked operating friendliness of the device according to the present invention is achieved in that the drive device is mounted in the lower region of a door transom of a car door and can be actuated by a maintenance person from the floor of a floor by hand or by means of electrically operated torque motor when the elevator car is positioned in the region of this floor and the shaft door and the car door are opened.

In order that the car roof during its lowering or raising movement does not come into contact with the inner sides of the car walls and in order to impart to the car roof, which serves as the maintenance platform, sufficient resistance to horizontal movements the elevator car is provided with at least one scissors mechanism which connects the car roof with the region of the roof frame of the elevator car to be vertically displaceable.

An additional improvement in the resistance to horizontal movements of the car roof is achieved in that the car roof lowered to its intended work level is connected with the region of the roof frame of the elevator car by at least one pair of flexible tension struts arranged crosswise and in a plane parallel to a car wall.

According to an advantageous embodiment of the present invention the stroke force required for raising the car roof is reduced in that at least one relief device, which bears a part of the weight of the lowerable car roof with the help of a biased spring, is present in the region of the roof frame of the elevator car.

A particularly preferred embodiment of the relief device comprises a cable drum, a relief cable winding up onto and unwinding from this cable drum and connected with the car roof, and a torsion spring driving the cable drum.

For increase in the functional reliability of the lowerable car roof there is present in the region of the roof frame of the elevator car at least one locking device preventing an unintended sinking of the lowerable car roof.

An advantageous development of the present invention consists in that the at least one locking device is unlockable means of at least one unlocking Bowden pull, wherein a pull means of the unlocking Bowden pull is connected with a turntable which is present at the drive device and which has to be manually displaced so that the crank or the torque motor can be coupled to the drive input shaft of the drive device. An automatic unlocking of the locking device prior to commencement of lowering of the car roof is thus guaranteed.

In a particularly advantageous embodiment of the present invention there is pivotably mounted on the lowerable car roof of the elevator car a climbing ladder which when the car roof is lowered to approximately half the height of the passenger compartment is pivotable down from this so that a maintenance person can go from the respective floor through the open shaft and car doors and by way of the pivoted-down climbing ladder onto the lowered car roof.

The climbing ladder is particularly economic, weight-saving and easily handled if it comprises a single central ladder post having a plurality of telescopically extensible segments.

A particularly advantageous embodiment of the elevator ladder results when each segment of the ladder post comprises a single rung, wherein a locking mechanism, by which each time two telescopic segments of the centre post can be mutually locked in the extended state and manually unlocked for pushing into one another, is present in the region of each rung.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic perspective view of an elevator car with lowerable car roof according to the present invention;

FIG. 2 is a schematic view a first alternate embodiment of a drive device for lowering and raising the car roof;

FIG. 3 is a cross-sectional view taken along the line III-III in FIG. 2;

FIG. 4 is a schematic view of a second alternate embodiment of a drive device for lowering and raising the car roof;

FIG. 5 is a cross-sectional view taken along the line V-V in FIG. 4;

FIG. 6 is an enlarged detail view of the drive device for lowering and raising the car roof shown in FIG. 2 with safety devices for preventing unauthorized actuation and unintended lowering of the car roof according to the present invention;

FIG. 7 is a cross-sectional view taken along the line VII-VII in FIG. 6;

FIG. 8 is a schematic view of locking means against dropping for the prevention of unintended dropping down of the car roof according to the present invention;

FIG. 9 is a schematic view of an elevator car with lowered car roof and pivoted-down, telescopically extensible climbing ladder according to the present invention;

FIG. 10 is an enlarged detail, as seen from the side of the elevator car, of the pivoting and extending function of the climbing ladder shown in FIG. 9;

FIG. 11 is a schematic view, as seen from the shaft door onto the elevator car, of the climbing ladder shown in FIG. 10; and

FIG. 12 is a cross-sectional view through the climbing ladder with a ladder post locking device for locking the telescopically extensible rectangular tubes (sections) of the climbing ladder.

### DESCRIPTION OF THE PREFERRED EMBODIMENT

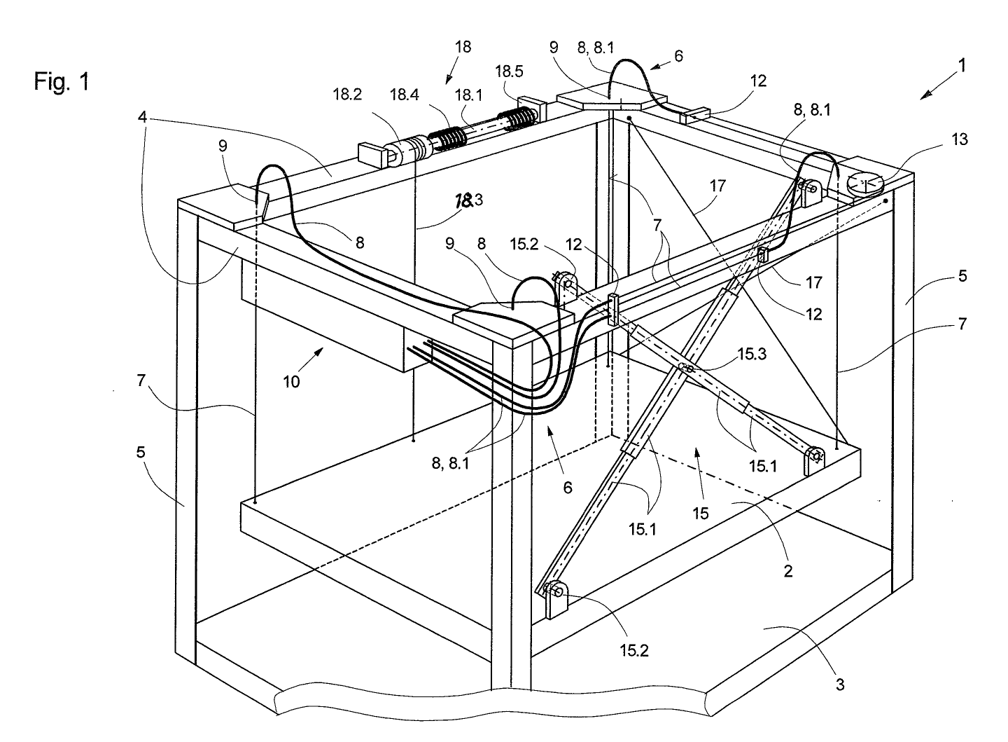

FIG. 1 schematically shows an elevator car 1 according to the present invention with a lowerable car roof 2, which in the illustrated lowered position can serve as a maintenance platform for maintenance or repair of elevator components arranged in the elevator shaft. The elevator car 1 comprises, as principal components, a car floor 3, a roof frame 4 which is connected with the car floor 3 by way of vertical posts 5, and the car roof 2, which is suspended at a pull means 7 by four Bowden pulls 6 and is lowerable with the help of these Bowden pulls 6 and which in normal operation is fixed within or below the roof frame 4. Car walls and car doors are not illustrated in FIG. 1 for reasons of clarity.

The Bowden pulls 6, of which each comprises a flexible casing tube 8, which is continuous or formed by several sections, with the pull means 7 guided therein, connect the lowerable car roof 2 with a drive device 10 which is fastened below a part of the roof frame 4 at the car door side, i.e. in the region of the door transom of the car door. The drive device 10, described in detail below, has the task of inducing all the pull means 7, which lead to the car roof 2, to synchronous longitudinal movements which produce a parallel lowering or raising of the car roof 2. Each of the pull means 7 is in that case guided at least partly in the flexible casing tube 8 up to a support point 9 at the roof frame, which lies vertically above a fastening point of the pull means 7 at the lowerable car roof. The casing tube 8 of each Bowden pull preferably runs without interruption from the drive device 10 to the support point 9 at the roof frame 4, where it is fixed. However, in certain cases it can be advantageous to divide the casing tube 8 up into two or more sections 8.1 spaced apart in longitudinal direction. In the case of interrupted casing tubes 8.1 the ends, which are associated with the interruption, of the casing tubes are non-displaceably fixed to the elevator car, preferably by means of retaining members 12 at the roof frame 4. The associated pull means 7 always extends without interruption from the drive device 10 through the continuous or interrupted casing tube 8, 8.1 via the support point 9 at the roof frame to the fastening point, which is disposed vertically thereunder, at the car roof, wherein it can always run only rectilinearly between the ends, which are associated with an interruption, of the casing tubes 8.1.

Each of the Bowden pulls 6 can in that case—for the purpose of circumventing obstacles, for aesthetic reasons or so as not to form an obstruction for a maintenance person standing of the car roof—be arranged in innumerable variants and, as well, be bent in all desirable directions. In special cases, for example for a deflection with obligatory small deflection radius, it can be useful to use a deflecting roller instead of a deflection of the pull means by means of casing tube, as is illustrated by way of a deflecting roller 13.

In order to ensure that the car roof 2 during its lowering and raising movement does not come into contact with the usually scratch-sensitive car walls or with the keyboard of a control panel and, in addition, has sufficient horizontal stability as maintenance platform the car roof 2 is, as recognizable in FIG. 1, additionally connected with the roof frame 4 by means of a scissors mechanism 15. Use can be made of a form of embodiment of the scissors mechanism in which each scissors arm 15.1 is connected with the car roof or with the roof frame pivotably and non-displaceably in each instance by one of its ends and via a horizontally displaceable arm joint by the respective other end.

FIG. 1 shows another form of embodiment of a scissors mechanism which functions with non-displaceable arm joints 15.2. This solution requires, however, that all four scissors arms 15.1 going out from a central scissors joint 15.3 have to be telescopically extensible. The extension length of the scissors arms is limited by integrated abutments so that the scissors mechanism 15 forms a limitation of the depth of lowering of the car roof and stabilizes the car roof in all horizontal directions in the case of maximum lowering. Advantageously an elevator car is equipped with two or more such scissors mechanisms.

The scissors arms can also serve for guidance of a power cable ensuring the feed of electrical energy from the elevator car to the lowerable car roof so as to supply, for example, the lighting fixtures of the illuminated roof. Such a power cable can be fixed to, for example, each section of a scissors arm, wherein the power cable forms, in the region of the transition between two mutually displaceable sections, a hanging loop so as to bridge over the mutual displacement of the scissors arms.

An additional horizontal stabilization of the lowered car roof 2 is achieved by a pair of tension struts 17 which are arranged crosswise in a plane parallel to a car wall and are flexible in bending, but longitudinally stiff and which connect the car roof 2 with the roof frame 4. With maximum lowering of the car roof the tension struts 17 are tensioned, whereby the latter, in co-operation with the pull means 7 of the Bowden pulls carrying the car roof, suppress horizontal movements of the car roof 2 directed parallel to the car wall.

FIG. 1 additionally discloses a relief device 18 which is based on the action of a biased spring and which bears a part of the weight of the car roof 2. Such a relief device has the advantage that the stroke force required for raising the car roof 2 is reduced, whereby the loading and thus the wear of the Bowden pulls 6 carrying the car roof as well as the actuation force, which has to be applied by a maintenance person, for the drive device 10 are less.

The illustrated relief device 18 comprises a cable drum 18.2 which is mounted on an elongated axle 18.1 and on which a relief cable 18.3 connected with the car roof 2 can be wound up or unwound in the manner of a thread. A helical spring 18.4 coupled by one end thereof with the cable drum 18.2 and by the other end thereof with a fixing part 18.5 is guided on the axle. The helical spring 18.4 is biased as a torsion spring, wherein it exerts a torsional moment on the cable drum 18.2 so that there results in the relief cable 18.3 an upwardly directed tension force which counteracts the weight force of the car roof 2. Advantageously a respective such relief device 18 is mounted on each of two opposite sides of the elevator car 1.

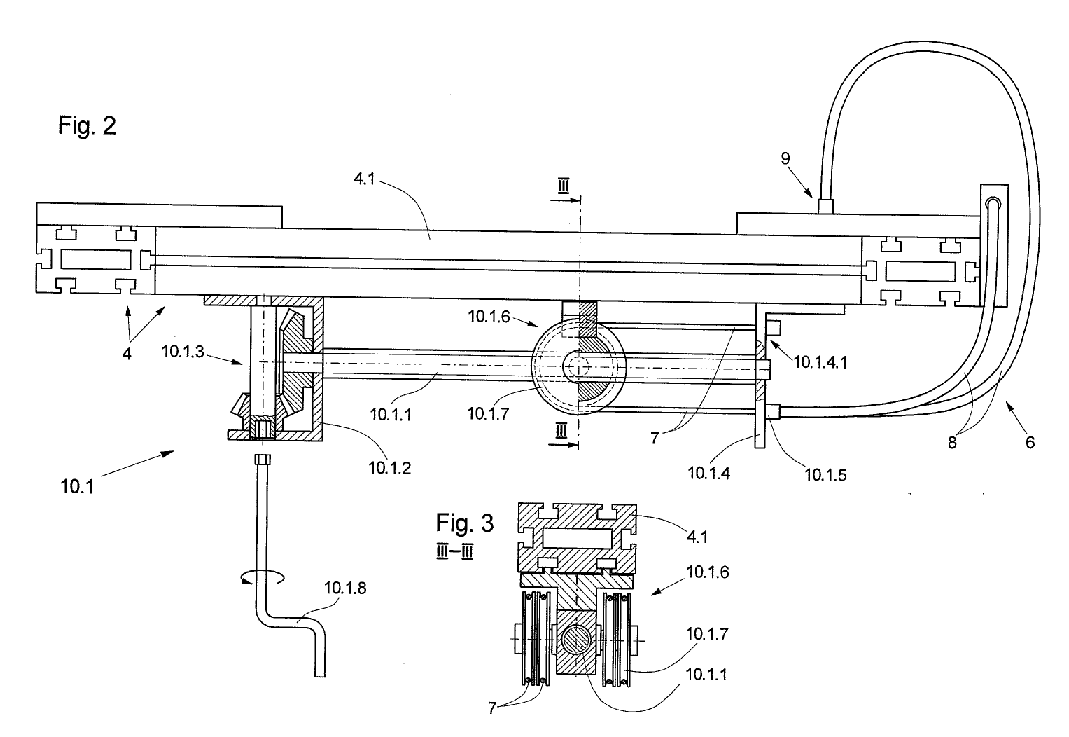

FIG. 2 shows a first alternate embodiment 10.1 of the drive device, which is denoted in FIG. 1 by 10, for lowering and raising the car roof, which is not illustrated here. FIG. 3 illustrates a cross-section through the drive device 10.1 in the region of a linearly displaceable drive part 10.1.6 described in the following. The roof frame 4, which is preferably made of drawn aluminium profiles with integrated connecting and fastening grooves, can be recognized. The drive device 10.1 is so fastened at its roof frame element 4.1 at the car door side that, when the car door is installed, the device is arranged between a door transom of the car door and the passenger compartment.

The drive device 10.1 substantially comprises the following components:
a drive spindle 10.1.1;
a first support 10.1.2 with an integrated bevel gear 10.1.3 for driving the drive spindle 10.1.1;
a second support 10.1.4 with a bearing point for the drive spindle as well as with connecting points 10.1.5 for the casing tubes 8 of several Bowden pulls 6 leading to the lowerable car roof; and

the drive part 10.1.6, which is linearly displaceable with the help of the drive spindle 10.1.1 and which is guided at the roof frame element 4.1, with pull means deflecting rollers 10.1.7 for movement of the pull means of the Bowden pulls 6 leading to the car roof.

The task of the drive device according to FIGS. 2 and 3 is to transmit a synchronous longitudinal movement to the pull means of the Bowden pulls 6 carrying, or lowering and raising, the car roof. The pull means 7 are fixed by their ends at the drive side to fixing points 10.1.4.1 of the second support 10.1.4, extend from there to the respectively associated pull means deflecting rollers 10.1.7 of the linearly displaceable drive part 10.1.6, loop around this and run in opposite direction back to the second support 10.1.4, where they enter the respectively associated flexible casing tubes 8, which are fixed to the second support, of the Bowden pulls 6, which guide the pull means to the support points 9, explained in connection with FIG. 1, at the car roof 4. The bevel gear 10.1.3 is driven and thus the drive spindle 10.1.1 set into rotation by a hand crank 10.1.8 or by means of an electrically operated torque motor—for example, by a drill—for lowering the car roof. Resulting from the rotation of the drive spindle is, for example, a linear displacement of the drive part 10.1.6 to the right so that the lower runs of the pull means 7 looped over the pull means deflecting rollers move to the right as a consequence of the weight force of the car roof acting thereon and—guided by the casing tubes—allow the car roof to sink. For raising the car roof the drive spindle 10.1.1 is rotated in opposite rotational direction so that the lower runs of the pull means 7 looped over the pull means deflecting rollers 10.1.7 are moved to the left.

It is readily recognizable that in the case of the drive arrangement illustrated in FIGS. 2 and 3 a displacement of the pull means 7 results which corresponds with twice the displacement travel of the linearly displaceable drive part 10.1.6. Thanks to this principle it is possible to achieve a sufficient stroke height of the lowerable car roof by one drive device, which can also be incorporated in narrow elevator cars parallel to the door transom of the car door. Quadruple displacement travels of the pull means could also be realized by additional non-displaceable and displaceable pull means deflecting rollers for the pull means 7 (not shown here).

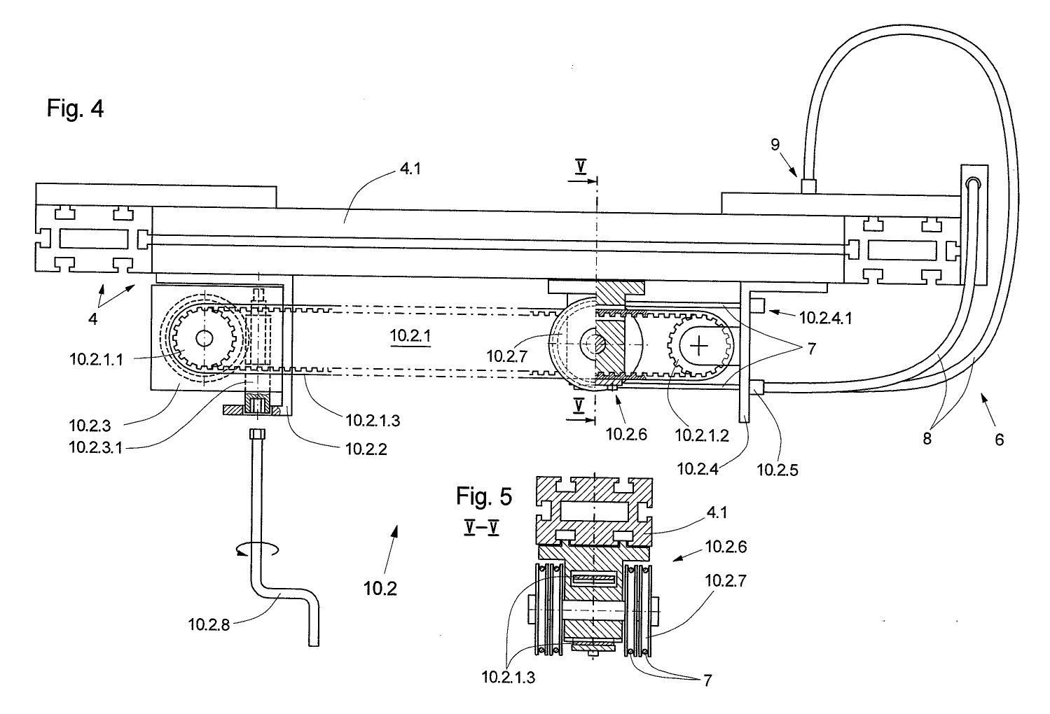

FIG. 4 shows a second alternate embodiment 10.2 of the drive device denoted in FIG. 1 by 10. FIG. 5 illustrates a cross-section through this drive device 10.2 in the region of a linearly displaceable drive part 10.2.6 described in the following. The roof frame 4 with its roof frame element 4.1 which is at the car door side and to which the drive device 10.2 is fastened, so that this is arranged between a door transom of the car door and the passenger compartment when the car door is installed, can again be recognized.

The drive device 10.2 substantially comprises the following components:
a cogged belt drive 10.2.1 comprising a drive cogged belt pulley 10.2.1.1, a deflecting cogged belt pulley 10.2.1.2 and a cogged belt 10.2.1.3;
a first support 10.2.2 with an integrated worm gear 10.2.3 and a drive input shaft 10.2.3.1 for driving the cogged belt drive 10.2.1;
a second support 10.2.4 with a bearing point for the deflecting cogged belt pulley 10.2.1.2 as well as with connecting points 10.2.5 for the casing tubes 8 of several Bowden pulls 6 leading to the lowerable car roof; and
the drive part 10.2.6, which is linearly displaceable with the help of the cogged belt drive 10.2.1 and which is guided at the roof frame element 4.1, with pull means deflecting rollers 10.2.7 for movement of the pull means 7 of the Bowden pulls 6 leading to the car roof.

The task of the drive device according to FIGS. 4 and 5 is the same as that of the drive device according to FIGS. 2 and 3, i.e. it is to transmit a synchronous longitudinal movement to the pull means 7 of the Bowden pulls 6 carrying, or lowering and raising, the car roof. The pull means 7 are fixed by their ends at the drive side to fixing points 10.2.4.1 of the second support 10.2.4, extend from there to the respectively associated pull means deflecting rollers 10.2.7 of the linearly displaceable drive part 10.2.6, loop around these and extend in opposite direction back to the second support 10.2.4, where they enter the respectively associated flexible casing tubes 8, which are fixed to the second support, of the Bowden pulls 6, which guide the pull means to the support points 9—explained in conjunction with FIG. 1—at the roof frame 4. The worm gear 10.2.3 is driven by way of the input drive shaft 10.2.3.1 and thus the cogged belt drive 10.2.1 set into motion by a hand crank 10.2.8 or by means of an electrically operated torque motor—for example by a drill—for lowering the car roof. A linear displacement of the drive part 10.2.6 coupled with the lower run of the cogged belt drive to, for example, the right results from the movement of the cogged belt 10.2.1 so that the lower runs of the pull means 7 looped over the pull means deflecting rollers 10.2.7 move to the right as a consequence of the weight force of the car roof acting thereon and—guided by the casing tubes—allow the car roof to sink. For raising the car roof the cogged belt drive 10.2.1 is moved in opposite rotational direction so that the lower runs of the pull means 7 looped over the pull means deflecting rollers 10.2.7 are moved to the left. A displacement of the pull means 7 and thus a stroke travel of the car roof corresponding with twice the displacement travel of the linearly displaceable drive part 10.2.6 also result with this variant of the drive device.

A chain drive can also be used instead of the cogged belt drive 10.2.1.

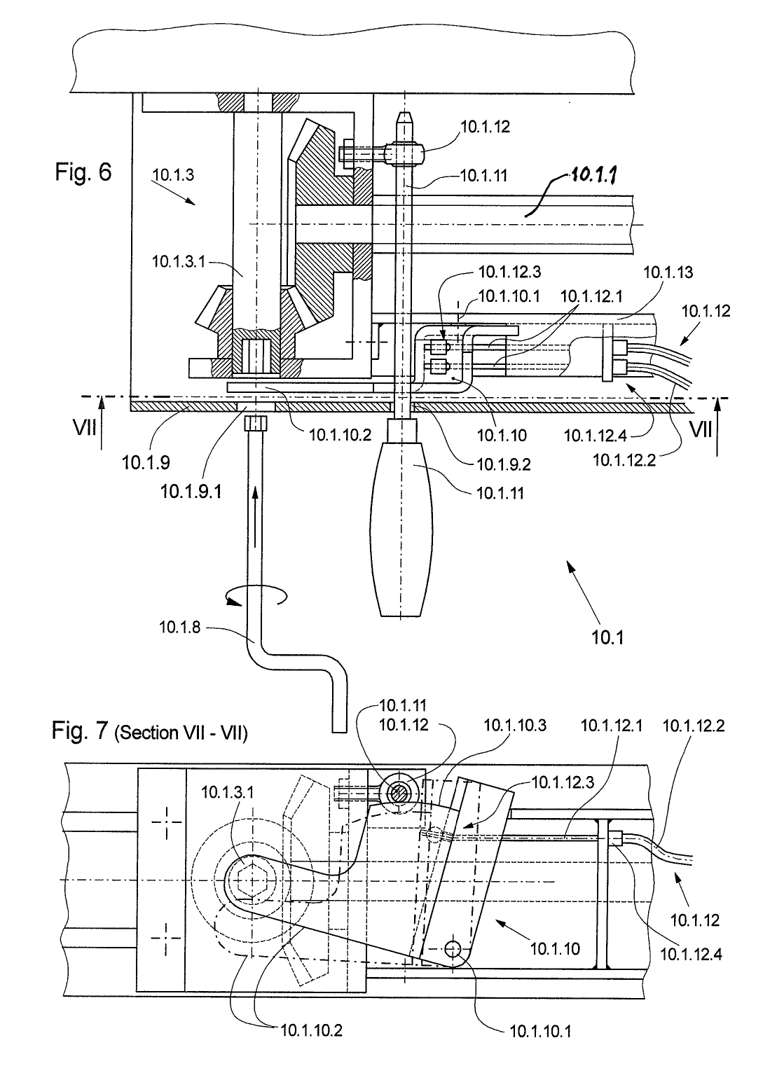

FIG. 6 shows details of the drive device 10.1, particularly safety devices against unauthorized actuation of the drive device and against unintended sinking of the car roof.

FIG. 7 illustrates a section VII-VII, which is seen from below, through the part of the drive device with the safety devices, wherein a cover 10.1.9 is regarded as not present.

The bevel gear 10.1.3 for manually actuated driving of the drive spindle 10.1.1 of the drive device, which is described by FIGS. 2 and 3, for lowering and raising the car roof can be recognized in FIG. 6. The drive of the bevel gear preferably takes place with the help of the hand crank 10.1.8 which is coupled with the input drive shaft 10.1.3.1 of the bevel gear 10.1.3 by means of a coupling device. As an alternative, use can be made of a manually guided, electrically operated torque motor. The hand crank or torque motor is handled, during lowering or raising of the car roof, by a maintenance person standing on a floor, wherein the shaft door and also the car door are opened.

The drive device 10.1 arranged in the region of the door transom of the car door is concealed by the cover 10.1.9 having a first opening 10.1.9.1 through which the hand crank 10.1.8 can be coupled with the drive input shaft 10.1.3.1. In order to hinder unauthorized actuation of the drive device this is equipped with a turntable 10.1.10 which is arranged between the cover 10.1.9 and the drive input shaft 10.1.3.1 and which is pivotably fastened to a U-shaped carrier section 10.1.13 by way of a rotational axle 10.1.10.1. In its self-centered basic setting the turntable blocks, by its blocking blade 10.1.10.2, introduction of the coupling member of the hand crank 10.1.8. In order for the maintenance person to be able to couple the hand crank with the drive input shaft 10.1.3.1 that person must introduce a screwdriver-like tool vertically into a slot-shaped second opening 10.1.9.2 and into the bore of a universal joint head 10.1.12 arranged vertically above the opening. Through pivoting of the tool in the direction predetermined by the slot-shaped second opening the shank of a tool 10.1.11 acts against an actuating runner 10.1.10.3 at the turntable 10.1.10, whereby the turntable is pivoted about its rotational axis 10.1.10.1 and its blocking blade 10.1.10.2 frees access to the drive input shaft 10.1.3.1. This setting of the turntable is illustrated in FIG. 7 by dot-dashed lines. The hand crank introduced into the coupling member of the drive input shaft now prevents the turntable from being able to pivot back into its self-centered basic setting.

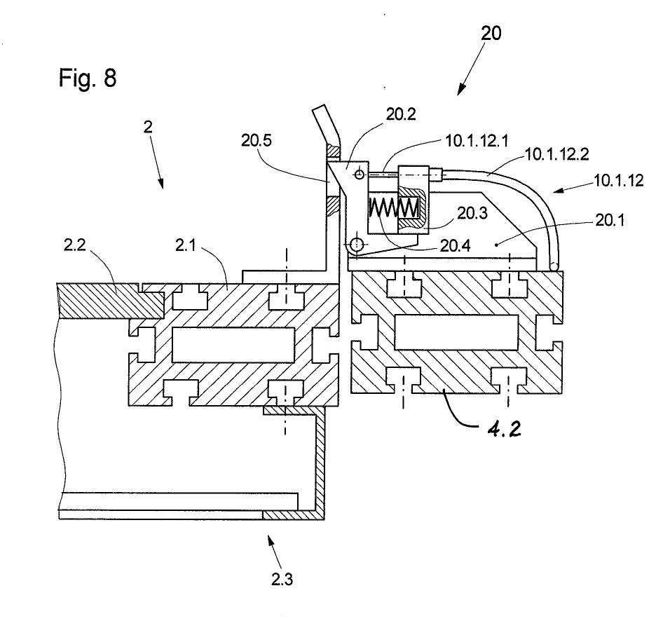

The movement of the turntable 10.1.10 produced for coupling the hand crank 10.1.8 is used in order to actuate, by way of unlocking Bowden pulls 10.1.12, the locking pawls of at least two locking devices preventing unintended lowering of the car roof. Such a locking device is illustrated in FIG. 8 and described in the following section. In FIGS. 6 and 7 the points at which the first ends of the pull means 10.1.12.1 of the unlocking Bowden pulls 10.1.12 are coupled to the turntable 10.1.10 are marked by 10.1.12.3 and those points at which the first ends of the associated flexible casing tubes 10.1.12.2 of the unlocking Bowden pulls 10.1.12 are fixed to the drive device are marked by 10.1.12.4.

It will be obvious that the afore-described safety devices are also usable with a drive device with cogged belt drive or chain drive.

FIG. 8 shows one of the locking devices 20, which prevent unintended dropping down of the car roof 2, explained in the foregoing. A cross-section through a roof frame element 4.2 of the roof frame 4 and an adjacent edge region of the car roof 2 with a roof frame profile 2.1, a roof plate 2.2 and a lighting cover 2.3 is illustrated. Fixed on the roof frame element 4.2 is the locking device 20 which comprises a pawl support 20.1, a locking pawl 20.2 pivotably mounted on the pawl support, and a holder 20.3, which is connected with the pawl support, for a pawl return spring 20.4 as well as for fastening the casing tube 10.1.12.2 of the unlocking Bowden pull 10.1.12 described in connection with FIGS. 6 and 7. A pawl abutment 20.5 in which the locking pawl 20.2 engages in its spring-centered rest setting, whereby any unintended lowering of the car roof 2 is prevented, is fixed on the roof frame profile member 2.1.

As already explained in connection with the safety devices, which were illustrated in FIGS. 6 and 7, at the drive device 10.1 the turntable 10.1.10 is displaced prior to actuation of the drive device, wherein the movement of the turntable is used for actuation of at least two locking Bowden pulls 10.1.12. These locking Bowden pulls lead from the drive device 10.1 to at least two locking devices 20 of the afore-described kind, wherein the pull means 10.1.12.1 of the locking Bowden pulls 10.1.12 draw the locking pawls 20.2 out of the region of the pawl abutments 20.5 against the force of the pawl return springs 20.4, so that the drive device 10.1 can lower the car roof 2 by way of the Bowden pulls carrying these. As soon as the car roof 2 after use thereof as a maintenance platform is raised back into its normal position and the hand crank 10.1.8 frees the turntable 10.1.10 in the drive device 10.1 the locking pawls through the force of the pawl return springs 20.4 detent again in the pawl abutments and again secure the car roof 2 against lowering.

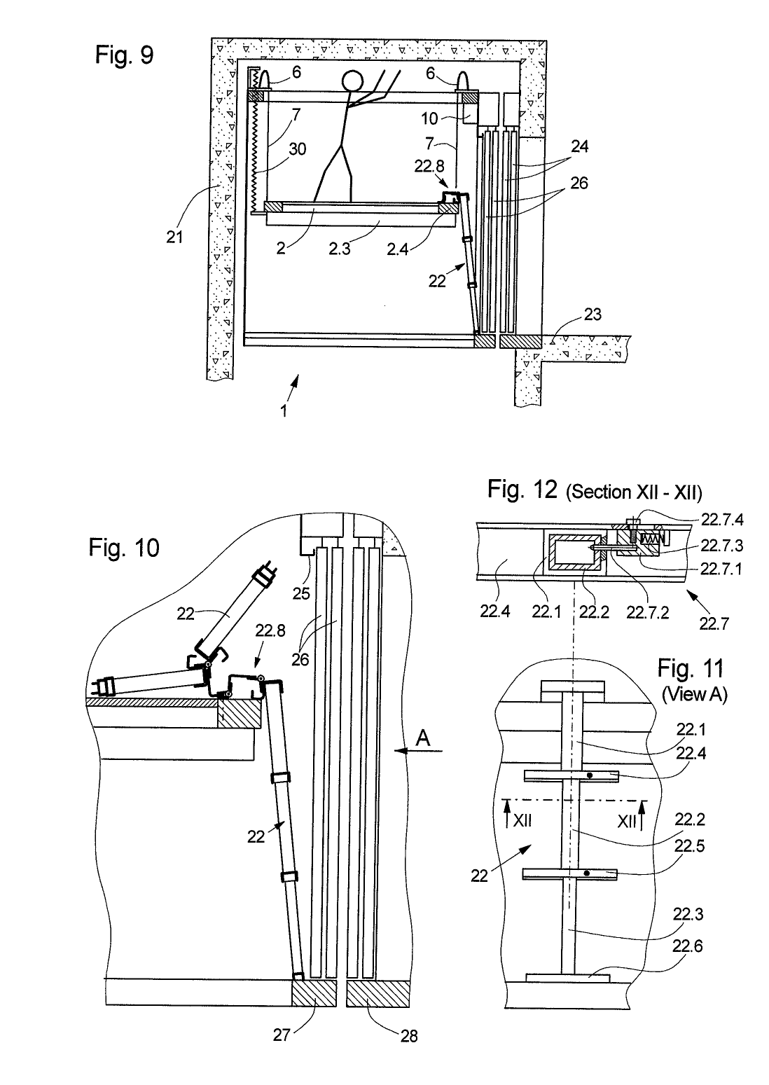

FIG. 9 schematically shows the elevator car 1 according to the present invention which is movable in an elevator shaft 21 and which is positioned at a floor 23 with a shaft door 24. A car door 26 and the shaft door 24 are opened. The car roof 2 is lowered at the pull means 7 of the Bowden pulls 6 and serves as a maintenance platform as can be recognized in the elevator car 1. The roof 2 is at approximately half the passenger compartment height in the lowered position. In addition, a climbing ladder 22 which assists a maintenance person in climbing from the floor 23 onto the lowered car roof 2 is illustrated. The climbing ladder 22 is telescopically extensible and during normal elevator operation is stowed in a pushed-together, approximately horizontal state on the car roof 2, wherein it is connected with a roof frame profile member 2.4 at the car door side by way of a joint combination 22.8. When the car roof 2 is lowered the climbing ladder 22 can be pivoted by a maintenance person, who is standing on a floor, through an angle of approximately 270° from its horizontal position on the car roof into a virtually vertical climbing position in the region of the opened elevator door 24 so that the maintenance person can comfortably climb onto the car roof 2 lowered as a maintenance platform. The foot of the climbing ladder 22 is in that case supported in a position on the car floor which makes it possible to close the elevator doors 24, 26 and to move the elevator car 1 at inspection speed to the inspection locations in the elevator shaft.

FIG. 10 shows the pivot process of the climbing ladder 22 in detail. Thanks to the joint combination 22.8, which comprises two joints, and the collapsible form of embodiment of the climbing ladder this can be pivoted below a door transom 25 of the open car door 26 when the car roof 2 is lowered and be brought into its almost vertical climbing position. As shown in FIGS. 10 and 11, rectangular tubes 22.1, 22.2, 22.3, which form three sections of the climbing ladder 22, are subsequently pulled out and mutually locked so that a rung 22.6 of the lower rectangular tube 22.3 reaches a car door threshold 27 or a shaft door threshold 28 and can be supported on one of the thresholds.

A so-called helix cable ensuring the feed of electrical energy from the elevator car 1 to the lowerable car roof 2 so as to supply, for example, the lighting fixtures 2.3 of the car roof is illustrated by reference numeral 30 in FIG. 9. This form of current supply is an economic, space-saving and easily installable alternative to a power cable, which is led through the scissors mechanism according to FIG. 1, or to separable plug connections.

FIG. 9 additionally allows recognition of the position of the afore-described drive device 10 in the region of the door transom 25 of the car door 26, wherein only a schematic cross-section of the drive device is indicated.

FIG. 11 shows a view A of the extensible climbing ladder 22 illustrated in FIG. 10, i.e. a view from the shaft door side onto the extended climbing ladder standing in climbing position. It can be seen that the climbing ladder 22 has a single central ladder post which comprises three sections formed by the three rectangular tubes 22.1, 22.2, 22.3, wherein the lower rectangular tube 22.3 of the lower section plugs into and is telescopically guided in the middle rectangular tube 22.2 of the middle section and the middle rectangular tube 22.2 of the middle section is plugged into and is telescopically guided in the upper rectangular tube 22.1 of the upper section. A respective rung 22.4, 22.5, 22.6 serving as a step rung of the climbing ladder is rigidly fastened to the respective lower end of each rectangular tube. The climbing ladder 22 is constructed to be extensible so as to enable it to be pivoted below the door transom 25 (FIG. 10) of the car door when the car roof 2 is lowered. The ladder can obviously also comprise a different number of sections.

FIG. 12 shows a section XII-XII through the climbing ladder 22 according to FIG. 11. There are illustrated the outer upper rectangular tube 22.1 of the upper section with the rung 22.4 fastened thereto, the middle rectangular tube 22.2 guided in the said rectangular tube and belonging to the middle section, and a ladder post locking device 22.7 which mutually locks the two rectangular tubes 22.1, 22.2 in a defined extended state. The ladder post locking device 22.7 comprises a locking member 22.7.1, which is displaceably mounted in the associated ladder rung 22.4 and in which is fixed a locking pin 22.7.2 which, in the extended state of the two participating rectangular tubes, detents in respectively corresponding bores of the two rectangular tubes through the force of an engagement spring 22.7.3 and mutually locks these tubes. For pushing together the two rectangular tubes 22.1, 22.2 belonging to this locking device the locking member 22.7.1 with the locking pins 22.7.2 can be retracted by means of an unlocking head 22.7.4 against the force of the engagement spring 22.7.3 to such an extent that the locking pin comes out of the bore of the inner rectangular tube, whereby the two rectangular tubes are again mutually displaceable. A duplicate of the same ladder post locking device is also present at the connecting point between the middle rectangular tube 22.2 and the lower rectangular tube 22.3 of the climbing ladder 22.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator car with a passenger compartment comprising:
a car roof moveable between a raised position closing an upper end of the passenger compartment and a lowered position in which said roof serves as a platform for maintenance personnel for performance of maintenance and checking operations; and
a movement device including a plurality of Bowden pulls connected between said roof and the car for moving said roof between the raised position and the lowered position.

2. The elevator car according to claim 1 wherein each of said Bowden pulls includes a flexible casing tube and pull means guided therein, wherein a first end of said pull means is connected to said roof and a corresponding end of said flexible casing tube is fixed to car components arranged in an upper region of the elevator car to be immovable.

3. The elevator car according to claim 2 wherein the car components include a roof frame connected with upper edges of side walls of the elevator car.

4. The elevator car according to claim 2 wherein each said pull means has a second end connected to a drive device, a movable drive part of said drive device co-operating with said pull means second ends such that a movement of said drive part produces a longitudinal displacement of said pull means in said flexible casing tubes, wherein ends of said casing tubes corresponding with said second ends of said pull means are fixed relative to said drive device.

5. The elevator car according to claim 4 wherein at least one of said flexible casing tubes has an interruption and ends of said at least one casing tube associated with said interruption are fixed to the elevator car by retaining members and said pull means rectilinearly extends through said interruption.

6. The elevator car according to claims 4 wherein said drive part is guided to be linearly displaceable.

7. The elevator car according to claim 6 wherein said drive device includes one of a threaded spindle, a cogged belt drive and a chain drive which linearly displaces said drive part of said drive device.

8. The elevator car according to claim 4 wherein said drive device includes a drive input shaft with a coupling member by which a maintenance person with the assistance of a hand crank or an electrically powered torque motor produces the movement of said drive part.

9. The elevator car according to claim 4 wherein pull means deflecting rollers are mounted at said drive part of said drive device and said pull means are guided in the region of said second ends from fixing points at said drive device to said pull means deflecting rollers, loop around said pull means deflecting rollers by 180° and extend in an opposite direction to connecting points for said casing tubes through which said pull means are led to said roof.

10. The elevator car according to claim 4 wherein said drive device is mounted in a region of a door transom of a car door of the elevator car.

11. The elevator car according to claim 1 including at least one scissors mechanism connecting said roof with a region of a roof frame of the elevator car to enable vertical displacement of said roof.

12. The elevator car according to claim 1 wherein when said roof in is said lowered position, said roof is connected with a region of an upper edge of the elevator car by at least one pair of flexible tension struts arranged crosswise and in a plane parallel to a car wall of the elevator car.

13. The elevator car according to claim 1 including at least one relief device bearing a portion of a weight of said roof by action of a biased spring and being located in a region of a roof frame of the elevator car.

14. The elevator car according to claim 13 wherein said relief device includes a cable drum, a relief cable winding up on and unwinding from said cable drum and connected with said roof and a torsion spring driving said cable drum in rotation.

15. The elevator car according to claim 1 including at least one locking device preventing unintended dropping down of said roof and being located in a region of a roof frame of the elevator car.

16. The elevator car according to claim 15 wherein said at least one locking device is unlockable by at least one unlocking Bowden pull, a pull means of said at least one unlocking Bowden pull is connected with a turntable which is located at said drive device and which has to be manually displaced so that a hand crank or a torque motor can be coupled to a drive input shaft of said drive device.

17. The elevator car according to claim 1 including a telescopically extensible climbing ladder pivotably mounted on said roof, said climbing ladder being pivotable out of a horizontal position on said roof below a door transom of a car door into an approximately vertical climbing position when said roof is in said lowered position.

18. The elevator car according to claim 17 wherein said climbing ladder includes a single central ladder post consisting of several telescopically extensible segments.

19. The elevator car according to claim 18 wherein each said segment of said ladder post has a single rung, and including a ladder post locking device mounted adjacent each said rung for releasably locking adjacent ones of said segments in an extended state.

20. A method for carrying out maintenance and inspection operations at a elevator installation having an elevator car with a moveable car roof in which the maintenance and inspection operations are performed by a maintenance person standing on the car roof, comprising:
a. connecting a plurality of Bowden pulls between the car roof and the elevator car;
b. actuating the Bowden pulls to lower the roof to a working level lying below a normal level of the roof; and
c. actuating the Bowden pulls to raise the roof to the normal level.

21. The method according to claim 20 wherein the Bowden pulls include a flexible casing tube and pull means guided therein, performing said step a. by connecting a first end of the pull means to the roof and connecting a second end of the pull means with a drive device, and performing said steps b. and c. by actuating the drive device.

22. The method according to claim 21 wherein said steps b. and c. are performed by the maintenance person with an open shaft door and an open car door of the elevator car positioned at a floor, and wherein the drive device is mounted in the region of a door transom of the car door is actuated by hand or by an electrically driven torque motor by the maintenance person standing on the floor or in the elevator car.

23. The method according to claim 22 including after said step b. is performed, pivoting down a telescopically extensible climbing ladder pivotably mounted on the car roof to enable the maintenance person to climb onto the lowered car roof.
